(19) United States
(12) Patent Application Publication
(10) Pub. No.: US 2012/0074801 A1
(43) Pub. Date: Mar. 29, 2012

(54) Magnetic Rotor Having Inset Bridges To Promote Cooling

(75) Inventors: Gerald W. BROWN, Radford, VA (US); Ethan Filip, Christiansburg, VA (US); Stephen Funk, Blacksburg, VA (US)

(73) Assignee: KOLLMORGEN CORPORATION, Radford, VA (US)

(21) Appl. No.: 13/215,296

(22) Filed: Aug. 23, 2011

Related U.S. Application Data
(60) Provisional application No. 61/386,811, filed on Sep. 27, 2010.

(51) Int. Cl. H02K 1/32

(52) U.S. Cl. 310/59

(57) ABSTRACT

A rotor arrangement with decreased fluid flow impedance and improved rotary motor cooling is mountable on a shaft for rotation relative to the stator of a rotary motor arrangement The rotor arrangement has a plurality of laminations joined together to form a multilayer laminated rotor with a plurality of magnet receptacles. Each of the laminations has a solid central section surrounding an opening within which the shaft is receivable, spokes extending substantially radially outwardly from said solid central section, ribs interposed between adjacent spokes, and bridges interconnecting the spokes and ribs. At least some of the bridges are inset from an outer diameter of the lamination toward the solid central section to decrease fluid flow impedance and improve rotary motor cooling.

This application claims priority under 35 U.S.C. §119(e) to U.S. provisional application Ser. No. 61/386,811, filed Sep. 27, 2010, the entire disclosure of which is incorporated by this reference into the present U.S. patent application.

### BACKGROUND OF THE INVENTION

1. Field of the Invention

The present invention relates to an interior permanent magnet synchronous motor having a rotor configuration permitting an increased flow of air or other fluid between the rotor and a stator of the motor for improved heat transfer.

2. Description of Related Art

U.S. Pat. No. 5,051,634 to Overton discloses an electric motor including a steel shaft surrounded by an iron sleeve on which four permanent magnets are mounted. A banding surrounds the rotor structure to hold the magnets in place. To effect a transfer of heat from windings of the motor to the motor housing, a heat spike is added into each stator slot of the motor.

U.S. Patent Application Publication 2008/0030108 to Trago et al. discloses a stepper motor having a rotor shaft with front and rear rotor segments disposed thereon. An aluminum housing and aluminum endbells conduct heat generated in the motor into a faceplate for improved performance.

FIG. 1 illustrates a known interior permanent magnet rotor lamination 10, in plan view, with indentations 12 on the rotor outer diameter 13. The rotor lamination illustrated in FIG. 1 is a single layer interior permanent magnet rotor lamination. Each indentation 12 is located between adjacent pairs of magnet receiving voids or orifices 14 and 16, 18 and 20, 22 and 24, and 26 and 28, and each magnet receiving void or orifice of these pairs is separated from the other such void or orifice by a thin bridge 30 of rotor lamination material. In operation, permanent magnets (not shown) are affixed within the voids or orifices to cooperate with windings disposed around poles of a stator, within which the rotor lamination 10 is rotatable. A rotor shaft (not shown) is receivable within a shaft opening 32 to impart rotational motion to the rotor.

The disclosures of U.S. Pat. No. 5,051,634 to Overton and U.S. Patent Application Publication 2008/0030108 to Trago et al. are both incorporated herein by reference in their entireties as non-essential subject matter.

### SUMMARY OF THE INVENTION

According to the present invention, an interior permanent magnet synchronous motor (IPMSM) has bridges, between the magnet layers of each pole and between poles, that are inset from the outer diameter of the rotor. Setting the bridges in from the outer diameter of the rotor provides an increased cross-sectional area in an air gap region, which increases the airflow from a fan and provides increased heat transfer from the winding and the rotor to the airflow, thereby cooling the motor with greater effect.

By way of the present invention, a rotor arrangement with decreased fluid flow impedance and improved rotary motor cooling is mountable on a shaft for rotation relative to a stator of a rotary motor arrangement The rotor arrangement has a plurality of laminations joined together to form a multilayer laminated rotor with a plurality of magnet receptacles. Each of the laminations has a solid central section surrounding an opening within which the shaft is receivable, spokes extending substantially radially outwardly from said solid central section, ribs interposed between adjacent spokes, and bridges interconnecting the spokes and ribs. At least some of the bridges are inset from an outer diameter of the lamination toward the solid central section to decrease fluid flow impedance and improve rotary motor cooling. In one configuration of the rotor arrangement, each lamination has an unobstructed channel for fluid on its outer circumference that is centrally located between the spokes, while, in another configuration, each lamination has a center pole tip on its outer circumference that is centrally located between the spokes.

In one preferred arrangement, the bridges extend approximately circumferentially. Additional, radially extending bridges may be provided to interconnect the solid central section and a plurality of the ribs. The ribs and the spokes can have protrusions defined thereon to properly position magnet elements between the protrusions and the outer bridges.

### BRIEF DESCRIPTION OF THE DRAWINGS

FIG. 1 is a plan view of a known interior permanent magnet rotor lamination.

FIG. 2 is a plan view of an interior permanent magnet rotor lamination in accordance with one embodiment of the present invention.

FIG. 3 is a plan view of part of an interior permanent magnet rotor lamination in accordance with another embodiment of the present invention.

### DETAILED DESCRIPTION OF THE INVENTION

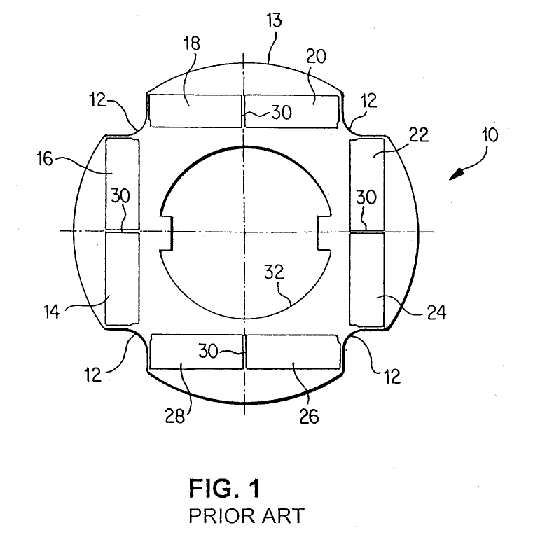

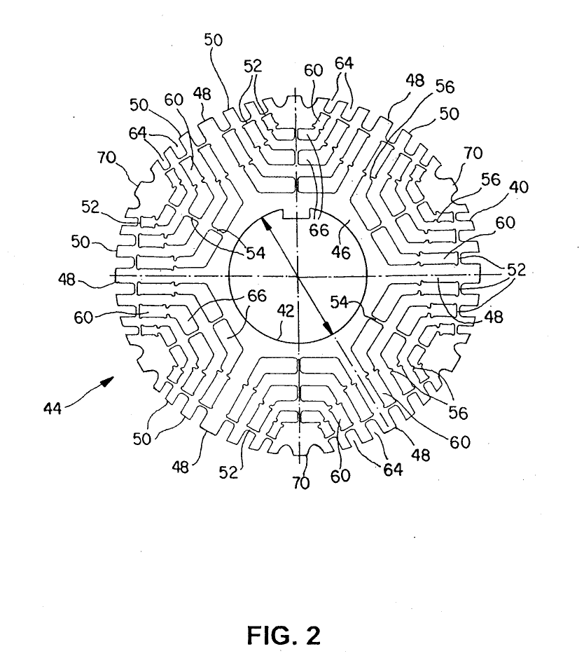

A lamina 40 used in production of a rotor according to the present invention is shown in plan view in FIG. 2. It will be understood by those of ordinary skill in the art that the lamina 40 shown in FIG. 2 is the endmost lamina of multiple (e.g., fifty) laminas joined together in a stack to produce a multilayer laminated rotor 44. The laminas may be stamped from sheets of steel or other suitable material. As with the known arrangement illustrated in FIG. 1, a rotor shaft (not shown) is receivable within a shaft opening 42 of the rotor 44 to impart rotational motion to the rotor.

Each lamina 40 may have a unitary, one piece construction, as shown, with a solid central section 46, in which the shaft opening 42 is provided, and a multiplicity of spokes 48 extending radially outward from the solid central section 46. A plurality of nested ribs 50 are received between adjacent spokes 48. The ribs 50 and the spokes 48 are interconnected by way of outer, approximately circumferentially extending bridges 52 and inner, approximately radially extending bridges 54, so that each rotor lamina 40, as a whole, is an integral element. In FIG. 2, six spokes 48, at sixty degree intervals, are shown, but other numbers of spokes could be used. Protrusions 56 are defined at appropriate locations on opposed edges of the spokes 48 and the ribs 50. These protrusions serve to properly position permanent magnet elements (not shown) receivable within magnet receptacles 60 defined between the protrusions 56 and the outer bridges 52.

The rotor 44 thus is formed as a multilayer IPM (interior permanent magnet) rotor, with outer bridges 52 that are inset from the outer diameter of the rotor 44. These bridges 52 of laminate material are not on the rotor outer diameter, as is traditional for multilayer IPM designs, but rather inset toward the inner diameter or solid central section 46 of the rotor 44. Insetting the bridges 52 in this way allows for recesses 64, which add significant cross-sectional area at the rotor outer diameter that is contiguous with the air or other fluid gap, within which cooling air or other fluid can flow. This area allows for a lower impedance path for fluid flow from a shaft mounted fan, and, therefore, provides improved cooling of the motor windings, which form the hottest part of the motor. Setting the outer bridges 52 in from the outer diameter of the rotor 44, in other words, provides an increased cross-sectional area in an air gap region, which increases the airflow from a fan (not shown) and provides increased heat transfer from the winding and the rotor to the airflow, thereby cooling the motor with greater effect. Air flow, of course, will also occur through passages 66 remaining between the magnet receptacles 60 and the radially extending bridges 54.

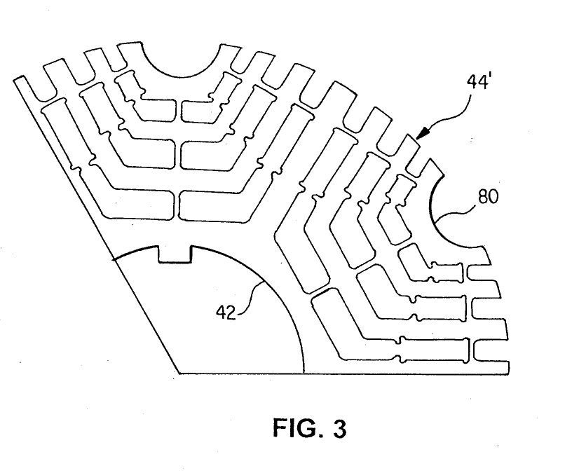

Each lamination of the rotor 44 illustrated in FIG. 2 is shown with center pole tips 70 located within what otherwise would be unobstructed air channels at the rotor outer circumference. The center pole tips 70 are integrally formed with the rest of the lamination, and are intended to increase the average torque produced and, at the same time, minimize variations in torque, or torque “ripple.” FIG. 3 illustrates a portion of a similar multilayer laminated rotor 44′, having outer air flow channels 80 unobstructed by center pole tips 70. A rotor constructed from laminations 44′ might have a somewhat greater degree of torque ripple, a lower average torque, or both, but would have greater cooling characteristics as well.

The foregoing disclosure has been set forth merely to illustrate the invention and is not intended to be limiting. Modifications of the disclosed embodiments incorporating the spirit and substance of the invention may occur to persons skilled in the art, and the invention should be construed to include everything within the scope of the invention ultimately claimed.

1. A rotor arrangement mountable on a shaft for rotation relative to a stator of a rotary motor arrangement having a plurality of laminations joined together to form a multilayer laminated rotor with a plurality of magnet receptacles, each of the laminations comprising:
a solid central section surrounding an opening within which the shaft is receivable,
spokes extending substantially radially outwardly from the solid central section,
ribs interposed between adjacent spokes,
bridges interconnecting the spokes and ribs,
wherein at least some of the bridges are inset from an outer diameter of the lamination toward the solid central section to decrease fluid flow impedance and improve rotary motor cooling.

2. The rotor arrangement of claim 1, wherein each lamination has an unobstructed channel for fluid on its outer circumference that is centrally located between the spokes.

3. The rotor arrangement of claim 1, wherein each lamination has a center pole tip on its outer circumference that is centrally located between the spokes.

4. The rotor arrangement of claim 1, wherein the bridges extend approximately circumferentially.

5. The rotor arrangement of claim 4, further comprising additional radially extending bridges that interconnect the solid central section and a plurality of the ribs.

6. The rotor arrangement of claim 1, wherein the ribs and the spokes include protrusions defined thereon to position magnet elements between the protrusions and the outer bridges.

7. The rotor arrangement of claim 1, wherein at least six of the spokes are provided.

8. The rotor arrangement of claim 1, wherein each of the bridges is inset from the outer lamination diameter.

9. The rotor arrangement of claim 2, wherein the bridges extend approximately circumferentially.

10. The rotor arrangement of claim 3, wherein the bridges extend approximately circumferentially.

11. A lamination, usable together with additional laminations to provide a rotor arrangement mountable on a shaft for rotation relative to a stator of a rotary motor arrangement by being joined together with the additional laminations to form a multilayer laminated rotor with a plurality of magnet receptacles, comprising:
a solid central section surrounding an opening within which the shaft is receivable,
spokes extending substantially radially outwardly from the solid central section,
ribs interposed between adjacent spokes,
bridges interconnecting the spokes and ribs,
wherein at least some of the bridges are inset from an outer diameter of the lamination toward the solid central section to decrease fluid flow impedance and improve rotary motor cooling.

12. The lamination of claim 11, including an unobstructed channel for fluid on its outer circumference that is centrally located between the spokes.

13. The lamination of claim 11, including a center pole tip on its outer circumference that is centrally located between the spokes.

14. The lamination of claim 11, wherein the bridges extend approximately circumferentially.

15. The lamination of claim 14, further comprising additional radially extending bridges that interconnect the solid central section and a plurality of the ribs.

16. The lamination of claim 11, wherein the ribs and the spokes include protrusions defined thereon to position magnet elements between the protrusions and the outer bridges.

17. The lamination of claim 11, wherein at least six of the spokes are provided.

18. The lamination of claim 11, wherein each of the bridges is inset from the outer lamination diameter.

19. The lamination of claim 12, wherein the bridges extend approximately circumferentially.

20. The lamination of claim 13, wherein the bridges extend approximately circumferentially.
